(19) United States
(12) Patent Application Publication
(10) Pub. No.: US 2007/0075170 A1
(43) Pub. Date: Apr. 5, 2007

(54) Document shredder with a continuously wound vinyl bag

(75) Inventor: Bum Kee Kim, Corona, CA (US)

Correspondence Address: AKERMAN SENTERFITT, 801 PENNSYLVANIA AVENUE N.W., SUITE 600, WASHINGTON, DC, 20004, US

(73) Assignee: Sinclair Worldwide, Inc., Ontario, CA (US)

(21) Appl. No.: 11/258,172

(22) Filed: Oct. 26, 2005

(30) Foreign Application Priority Data
Sep. 30, 2005 (KR) 2005-92076

(51) Int. Cl. B02C 18/18

(52) U.S. Cl. 241/100; 241/236

(57) ABSTRACT

A document shredder with a continuously wound vinyl bag, includes a shredding portion, a collection portion and a cover case. The shredding portion includes an intermediate plate having a drop opening through which the shredded strips of paper fall, and in which a control circuit is mounted, and a pair of cutting rolls disposed above the drop opening, and a top member including a feed opening disposed above the cutting rolls. The collection portion placed downward from the shredding portion, includes a housing frame of which the center is opened, and a roll unit of a vinyl bag in which the paper to be shredded is collected. The cover case includes a support board, side walls which are vertically elevated along three surfaces of the support board, a door in which the vinyl bag filled with the shredded strips of paper is cut and discharged, and the top member which is assembled with the upper portions of the side walls and the door.

This application claims priority from Korean Patent Application No. 2005-92076, filed Sep. 30, 2005, the entire contents of which are herein incorporated by reference to the extent allowed by law.

### BACKGROUND OF THE INVENTION

The present invention relates to a document shredder with a continuously wound vinyl bag, and more particularly, to a document shredder with a continuously wound vinyl bag which can cut the destroyed paper into narrow strips or chips and simultaneously collect the shredded strips in the vinyl bag.

Conventionally, there have been known cutting apparatuses for shredding paper documents having only a shredding function and garbage containers with a collection bag therein.

The conventional cutting apparatus for a document shredder which cuts the paper into narrow strips or chips, is provided with only a loading portion for receiving the shredded strips of destroyed paper. When the shredded strips are overloaded in excess of the shredder's capacity and should be removed, it should be transferred to a garbage bag for manual disposal. Therefore, there is inconvenience that the shredded strips of the paper may be scattered indoors and the scattered strips should be swept up in the course of collection, and also this course may cause pollution of the indoor air due to fine dirty materials being scattered. Accordingly, a cutting apparatus for a document shredder which can allow the shredded strips of the destroyed paper documents to be automatically housed in a collection bag without scattering after the paper documents are shredded, is needed.

### BRIEF DESCRIPTION OF THE DRAWINGS

The preferred embodiments are described with reference to the drawings wherein:

FIG. 1 is a perspective view showing a document shredder with a continuously wound vinyl bag in one embodiment in accordance with the present invention;

FIG. 2 is a partially exploded perspective view showing a document shredder with a continuously wound vinyl bag in one embodiment in accordance with the present invention;

FIG. 3 is an exploded perspective view showing a document shredder with a continuously wound vinyl bag in one embodiment in accordance with the present invention;

FIG. 4 is a sectional view showing a document shredder with a continuously wound vinyl bag in one embodiment in accordance with the present invention; and

FIG. 5 is a perspective view showing a top member of a document shredder with a continuously wound vinyl bag in accordance with another embodiment of the present invention.

### SUMMARY OF THE INVENTION

In order to solve the above problem, an object of the present invention is to provide a document shredder with a continuously wound vinyl bag which can cut the destroyed paper into narrow strips or chips and simultaneously collect the shredded strips in the vinyl as soon as the paper is shredded.

In order to achieve the above object, there is provided a document shredder with a continuously wound vinyl bag, including:

a shredding portion; a collection portion, placed downward from the shredding portion, including a housing frame of which the center is opened, and a roll unit of a vinyl bag which is inserted into the housing frame so that destroyed paper to be shredded in the shredding portion is collected in the vinyl bag; and a cover case.

It is preferable that shredding portion includes an intermediate plate which includes a drop opening and in which a control circuit is mounted; a pair of cutting rolls disposed above the drop opening in the intermediate plate, which is controlled by the control circuit; and a top member including a feed opening disposed right above the cutting rolls.

It is preferable that the cover case includes a support board, side walls which are vertically elevated along three surfaces of the support board, a door in which the vinyl bag filled with the shredded strips of the paper is cut and discharged, and the top member of the shredding portion which is assembled with the upper portions of the side walls and the door, including the feed opening.

It is preferable that the housing frame includes an opening at the center thereof, vertical walls elevated from the bottom thereof, and a lower edge which horizontally extends from the bottom of the vertical walls.

It is preferable that the cover case further includes a locking unit which is horizontally arranged at a predetermined location in the side walls and the door and is joined with the lower edge of the housing frame.

It is preferable that the door is provided with a magnet between the adjacent side walls for attachment/detachment and opening/closing.

It is preferable that the top member further includes an on/off switch.

### DETAILED DESCRIPTION OF THE INVENTION

One embodiment of the present invention will be described in detail with reference to the accompanying drawings.

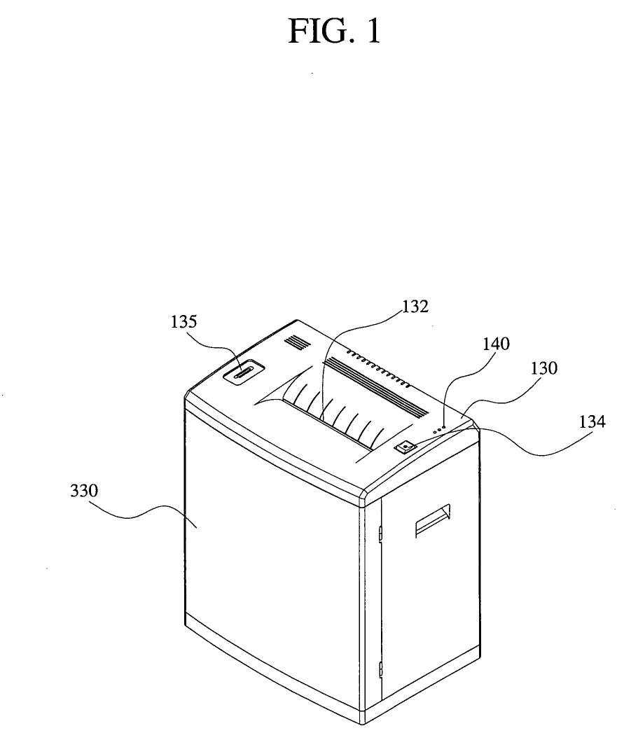

FIG. 1 is a perspective view showing a document shredder with a continuously wound vinyl bag in accordance with the present invention.

As shown in FIG. 1, the document shredder with the continuously wound vinyl bag according to the present invention comprises a top member 130, a cover case 300 and a door 330. The top member 130 comprises a feed opening 132, an on/off switch 134, a clip groove 135, and an LED 140. The document shredder is constructed with the cover case 300 having a plurality of top, side and bottom walls and the door 330.

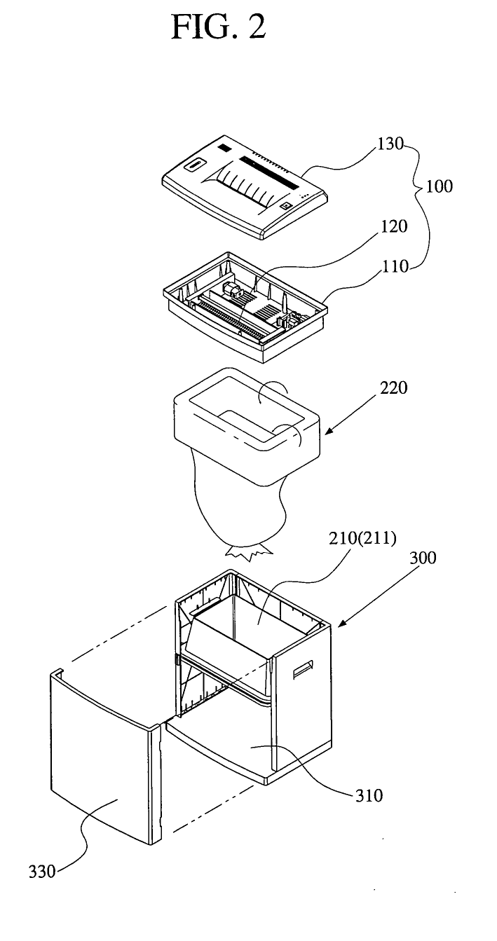

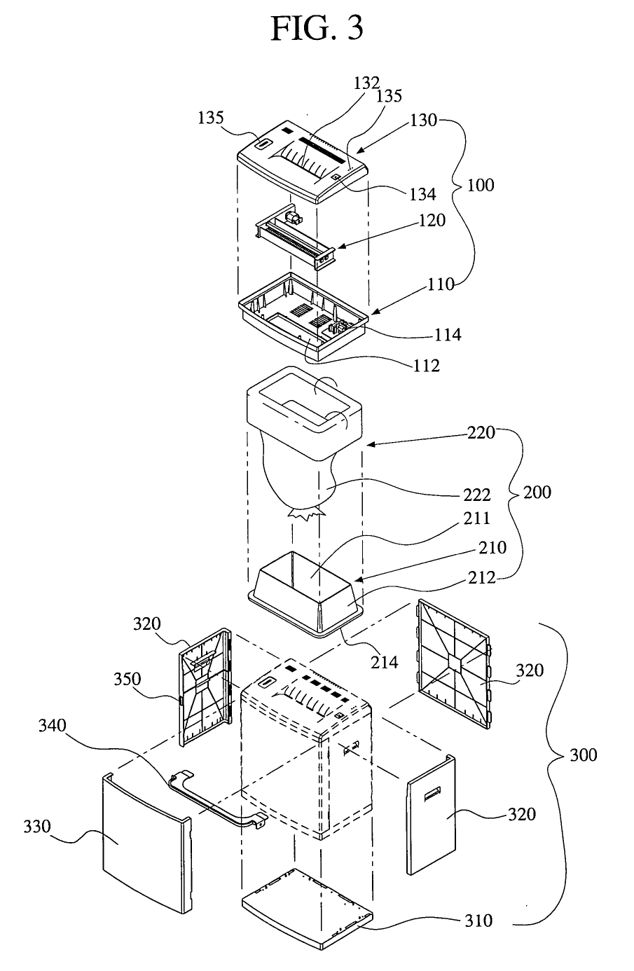

FIG. 2 is a partially exploded perspective view showing a document shredder with a continuously wound vinyl bag in accordance with the present invention, and FIG. 3 is an exploded perspective view showing a document shredder with a continuously wound vinyl bag in accordance with the present invention.

Referring to FIGS. 2 and 3, the document shredder with the continuously wound vinyl bag comprises a shredding portion 100, a collection portion 200 and a cover case 300.

First, the shredding portion 100 comprises an intermediate plate 110 which includes a drop opening 112 and in which a control circuit 114 is mounted, and a pair of cutting rolls 120 disposed above the drop opening 112 in the intermediate plate 110, and a top member 130 including a feed opening 132 disposed right above the cutting rolls 120.

The top member 130 includes the feed opening 132, an on/off switch 134, a clip groove 135 and an LED 140.

When the shredded strips of destroyed paper are overloaded in excess of the shredder's capacity, a predetermined upper portion of a continuously wound vinyl bag 222 is cut with a cutting unit formed in the inside of the door 330 or a separate cutting blade (not shown), and is bound and then discharged.

The collection portion 200 which is placed downward from the shredding portion 100, includes a housing frame 210 of which the center is opened, and a roll unit 220 of the vinyl bag 222 in which the paper strips to be shredded in the shredding portion 100 are collected.

The housing frame 210 includes an opening 211 at the center thereof, vertical walls 212 elevated from the bottom thereof, and a lower edge 214 which horizontally extends from the bottom of the vertical walls, and the lower edge 214 is joined with a locking unit 340.

A cover case 300 comprises a support board 310, side walls 320 which are vertically elevated along three surfaces of the support board 310, a door 330 in which the vinyl bag filled with the shredded strips of the paper is cut and discharged, and the top member 130 which is assembled with the upper portions of the side walls 320 and the door 330, on which the feed opening 132 is provided.

Particularly, the housing frame 210 contains the roll unit 220 of the wound vinyl bag 222. The lower edge 214 of the housing frame 210 is safely fixed at the locking unit 340 which is horizontally arranged at a predetermined inner location of the cover case 300 composed of the side walls 320 and the door 330.

Also, the door 330 is provided with a magnet 350 between the adjacent side walls 320 for attachment or detachment, which may be modified or changed to be hinged or to be provided with a grip.

The document shredder with the continuously wound vinyl bag according to the present invention is vertically elevated with the side walls 320 formed along three surfaces of the support board 310 and the door 330, and the lower edge 214 of the housing frame 210 is safely fixed at the locking unit 340 which is horizontally arranged at the inner position of the cover case 300. A housing frame 210 is provided, into which the roll unit 220 of the vinyl bag 222 is inserted. The intermediate plate 110 is mounted on the housing frame 210. The cutting rolls 120 in the intermediate plate 110 are assembled to fit with the feed opening 132 of the top member 130.

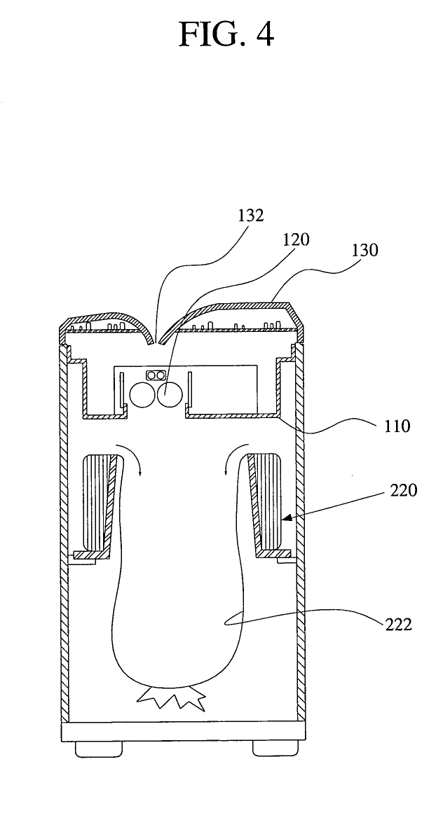

FIG. 4 is a sectional view showing a document shredder with a continuously wound vinyl bag in accordance with the present invention. As shown in FIG. 4, the document shredder is supplied with a predetermined power source via operating the on/off switch 134, and a driving motor (not shown) is driven, and then the cutting rolls 120 are rotated with a pulley and belt (not shown).

The number of rotation of the cutting rolls 120 is controlled by the control circuit of the driving motor, but the detailed explanation on an operation of the control circuit will be omitted herein.

At the time when the cutting rolls 120 are rotated by turning the on/off switch 134 on, the destroyed paper is supplied to the feed opening 132, and shredded and then dropped downward.

The shredded strips of the destroyed paper drop, and are automatically collected into the vinyl bag 222 which is arranged in a wound form.

When the shredded strips of the destroyed paper are overloaded in excess of the shredder's capacity, a predetermined upper portion of the vinyl bag 222 is cut, bound and discharged through the door 330. Changes or modifications that the loading of the shredded paper can be detected by a sensor (not shown) and displayed on the top member.

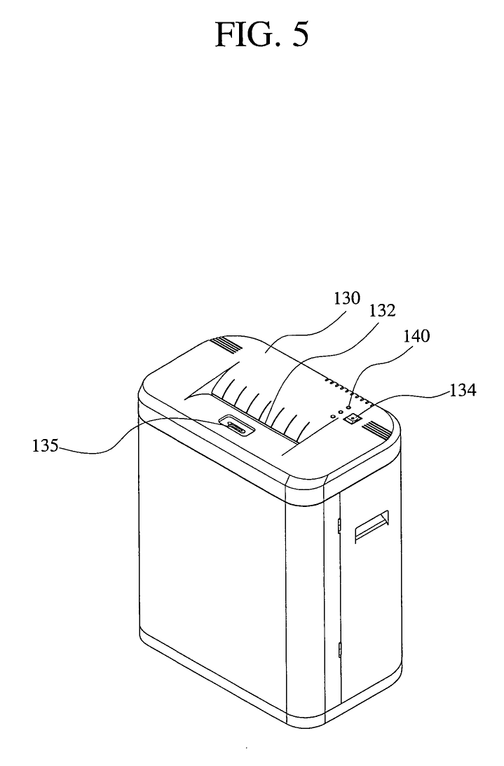

FIG. 5 is a perspective view showing a top member of a document shredder with a continuously wound vinyl bag in accordance with another embodiment of the present invention.

As shown in FIG. 5, a wide range of changes and modifications of the cover case according to the present invention can be made. Also, the technical feature of the present invention is to provide both shredding function and collection function at a time, by including the continuously wound vinyl bag for collection and disposal.

As described above, the present invention improves a drawback of the conventional document shredder apparatus. At the time when the shredded strips of the destroyed paper drop, they are automatically collected into the vinyl bag without being scattered indoors, and the bag filled with the shredded strips are bound and then discharged. Therefore, the present invention provides the effect to improve the problem of the conventional document shredder apparatus that the shredded strips of the paper loaded in a housing space should be transferred to a separate garbage bag manually.

While only certain embodiments of the invention have been specifically described herein, it will be apparent that numerous modifications may be made thereto without departing from the spirit and scope of the invention.

What is claimed is:

1. A document shredder with a continuously wound vinyl bag, comprising:
a shredding portion;
a collection portion, placed downward from said shredding portion, comprising a housing frame of which the center is opened, and a roll unit of a vinyl bag which is inserted into said housing frame so that destroyed paper to be shredded in said shredding portion is collected in the vinyl bag; and
a cover case.

2. A document shredder according to claim 1, wherein said shredding portion comprises an intermediate plate which includes a drop opening and in which a control circuit is mounted;
a pair of cutting rolls disposed above the drop opening in the intermediate plate, which is controlled by the control circuit; and
a top member including a feed opening disposed above the cutting rolls.

3. A document shredder according to claim 1, wherein said cover case comprises a support board, side walls which are vertically elevated along three surfaces of the support board, a door in which the vinyl bag filled with the shredded strips of the paper is cut and discharged, and the top member of said shredding portion which is assembled with the upper portions of the side walls and the door.

4. A document shredder according to claim 1, wherein said housing frame comprises an opening at the center thereof, vertical walls elevated from the bottom thereof, and a lower edge which horizontally extends from the bottom of the vertical walls.

5. A document shredder according to claim 2, wherein said housing frame comprises an opening at the center thereof, vertical walls elevated from the bottom thereof, and a lower edge which horizontally extends from the bottom of the vertical walls.

6. A document shredder according to claim 3, wherein said housing frame comprises an opening at the center thereof, vertical walls elevated from the bottom thereof, and a lower edge which horizontally extends from the bottom of the vertical walls.

7. A document shredder according to claim 4, wherein said cover case further comprises a locking unit which is horizontally arranged at a predetermined location in the side walls and the door and is joined with the lower edge of the housing frame.

8. A document shredder according to claim 5, wherein said cover case further comprises a locking unit which is horizontally arranged at a predetermined location in the side walls and the door and is joined with the lower edge of the housing frame.

9. A document shredder according to claim 6, wherein said cover case further comprises a locking unit which is horizontally arranged at a predetermined location in the side walls and the door and is joined with the lower edge of the housing frame.

10. A document shredder according to claim 1, wherein said door is provided with a magnet between the adjacent side walls for attachment/detachment and opening/closing.

11. A document shredder according to claim 2, wherein said top member further comprises an on/off switch.
